(19) United States
(12) Patent Application Publication
(10) Pub. No.: US 2025/0217627 A1
(43) Pub. Date: Jul. 3, 2025

(54) WEIGHT ROUNDING OPTIMIZATION VIA SIGNED GRADIENT DESCENT

(71) Applicant: Intel Corporation, Santa Clara, CA (US)

(72) Inventors: Wenhua Cheng, Shanghai (CN); Haihao Shen, Shanghai (CN); Weiwei Zhang, Shanghai (CN)

(21) Appl. No.: 18/399,228

(22) Filed: Dec. 28, 2023

(51) Int. Cl. G06N 3/0455

(52) U.S. Cl. CPC G06N 3/0455

(57) ABSTRACT

Systems, apparatuses and methods may provide for technology that determines a tensor based on a signed gradient descent value and modifies a rounding operation with respect to weights in a large language model (LLM) based on the tensor. The rounding operation may be modified on a per block basis.

### BACKGROUND

A large language model (LLM) is a type of language model notable for the ability to achieve general-purpose language understanding and generation. LLMs acquire these abilities by using large amounts of data to learn billions of parameters during training and consuming large computational resources during training and operation (e.g., inference). Weight data used by LLMs may originally be in a relatively high precision format such as, for example, the 16-bit floating point (FP16) format. Quantizing the weight data used by LLMs to a lower-precision format such as, for example, 4-bit integer (INT4), can reduce the computational demands of these modern architectures. Conventional quantization approaches, however, may encounter accuracy problems that negate the benefits of quantization.

### BRIEF DESCRIPTION OF THE DRAWINGS

The various advantages of the embodiments will become apparent to one skilled in the art by reading the following specification and appended claims, and by referencing the following drawings, in which:

FIG. 1 is a comparative illustration of an example of rounding solutions in architectures having relationships between weights;

FIG. 2 is an illustration of an example of a modified rounding operation procedure according to an embodiment;

FIG. 3 is an illustration of an example of pseudocode to train a tensor to modify a rounding operation according to an embodiment;

FIG. 4 is a flowchart of an example of a method of rounding weights in a large language model (LLM) according to an embodiment;

FIG. 5 is a flowchart of an example of a method of obtaining a signed gradient descent value according to an embodiment;

FIG. 6 is a block diagram of an example of a performance-enhanced computing system according to an embodiment;

FIG. 7 is an illustration of an example of a semiconductor package apparatus according to an embodiment;

FIG. 8 is a block diagram of an example of a processor according to an embodiment; and

FIG. 9 is a block diagram of an example of a multi-processor based computing system according to an embodiment.

### DETAILED DESCRIPTION

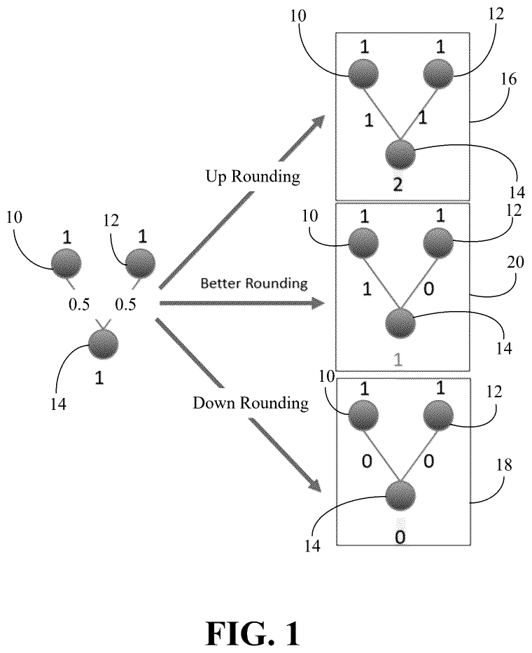

FIG. 1 shows a first neuron 10 (e.g., of a first layer in an artificial neural network/ANN), wherein the first neuron 10 has a value of “1” and an output weight of “0.5”. A second neuron 12 (e.g., of the first layer in the ANN) also has a value of “1” and an output weight of “0.5”. The first and second neurons 10, 12 feed a third neuron 14 (e.g., of a second layer in the ANN), which has a value of “1” due to the weights of the first and second neurons 10, 12 being applied to the respective values of the first and second neurons 10, 12.

An up rounding solution 16 rounds both weights of the first and second neurons 10, 12 to “1”. Accordingly, the value of the third neuron 14 changes to “2” (e.g., resulting in significant error from the true value of “1”) due to the weights of the first and second neurons 10, 12 being applied to the respective values of the first and second neurons 10, 12. A down rounding solution 18 rounds both weights of the first and second neurons 10, 12 to “0”. Accordingly, the value of the third neuron 14 changes to “0” (e.g., resulting in significant error from the true value of “1”) due to the weights of the first and second neurons 10, 12 being applied to the respective values of the first and second neurons 10, 12.

By contrast, an enhanced rounding solution 20 learns and/or models the relationship/correlation between the weights of the first and second neurons 10, 12 via the technology described herein. Accordingly, the enhanced rounding solution 20 rounds the weight of the first neuron 10 up to “1” and rounds the weight of the second neuron 12 down to “0” based on the relationship. As a result, the value of the third neuron 14 remains at “1” (e.g., no error). The enhanced rounding solution 20 therefore improves accuracy.

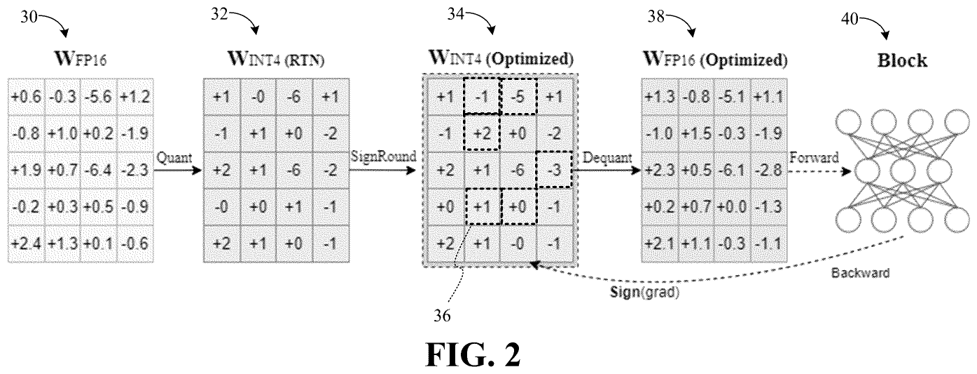

Turning now to FIG. 2, a modified rounding operation procedure is shown in which a first plurality of weights 30 are in a relatively high precision format (e.g., 16-bit floating point/FP16). A standard rounding-to-nearest (RTN) quantization operation is applied to the first plurality of weights 30 to obtain a rounded plurality of weights 32, wherein the rounded plurality of weights 32 are in a lower-precision format such as 4-bit integer (INT4). A fine-tuning operation (e.g., “SignRound”) is applied to the rounded plurality of weights 32 to obtain an optimized plurality of weights 34. As will be discussed in greater detail, a signed gradient descent value is used to generate a tensor, which modifies the original RTN quantization operation to improve accuracy. For example, a weight 36 is changed from “+0” to “+1” in the optimized plurality of weights 34 (e.g., even though traditional RTN quantization would round the original value of “+0.3” down to “+0”.

The optimized plurality of weights 34 may be dequantized (e.g., via a standard dequantization operation) to obtain a plurality of dequantized weights 38. In the illustrated example, the plurality of dequantized weights 38 are applied to a block 40 (e.g., several linear layers of an ANN) during a forward propagation procedure). In an embodiment, the forward propagation procedure determines the losses associated with using the dequantized weights 38 in the block 40. A backward propagation procedure modifies the signed gradient descent value on a per block basis (e.g., block-wise output reconstruction) to modify the optimized plurality of weights 34 (e.g., via the tensor) and reduce the losses. The illustrated forward and backward propagation procedures are relatively “lightweight” and may be repeated (e.g., for a configurable number of iterations T) to ensure that the optimized plurality of weights 34 converge on an acceptable level of losses/error. In one example, the trained fine-tuning operation is deployed for inference operation as a weight only quantization solution (e.g., no quantization of input activation functions). Example deep learning domains that can benefit from the technology described herein include natural language processing (NLP), computer vision (CV), and so forth.

To quantize the weights, an operation shown below may be applied, in which zero points are ignored for simplicity.

$$\tilde{W} = s * clip ( ⌊ \frac{W}{s} ⌉ , n , m ) , n , m ∈ ℕ \qquad ( 1 )$$

where s denotes the quantization scale with positive elements, and └⋅┐ is a rounding operation, in which RTN is the dominated method. Though concise, RTN quantizes each element independently and loses the compatibility of modeling the correction between different weights or activations (see, e.g., FIG. 1).

To make the rounding operation more flexible, a tensor V with the same shape of W is introduced, and each element of V is in the range [−0.5, 0.5] that enforces the changes only affect the rounding value.

$$\tilde{W} = s * clip ( ⌊ \frac{W}{s} + V ⌉ , n , m ) , n , m ∈ ℕ \qquad ( 2 )$$

So, the final optimization task could be formulated to reconstruct the output of the layer.

$$L = {‖ WX - \tilde{W} X ‖}_{F}^{2} \qquad ( 3 )$$

$${arg min}_{V} {‖ WX - \tilde{W} X ‖}_{F}^{2} \qquad ( 4 )$$

where L is the loss, X is the input of the layer, and ∥˜∥_{F} denotes the Frobenius norm. Since v has a clear boundary (e.g., [−0.5, 0.5]), and the magnitude of gradients varies significantly, to improve the converging speed and stabilize the tuning, scaled signed gradient descent is used to optimize this task. More precisely, the below formula is followed to approach the sub-optimal solution.

$${V}_{t + 1} = {V}_{t} - lr * sign ( \frac{\partial L}{\partial V} ) \qquad ( 5 )$$

$$s . t . \vert {\sum }_{t} lr * sign ( \frac{\partial L}{\partial V} ) \vert \leq B$$

Further, by employing a straight-through estimator (STE), it can be readily demonstrated that

$$sign ( \frac{\partial L}{\partial V} ) = sign ( \frac{\partial L}{\partial W} )$$

in Eq. (3) since all elements of s are positive.

$$\frac{\partial L}{\partial W} = - 2 ( WX - \tilde{W} X ) {X}^{T} \qquad ( 6 )$$

$$\frac{\partial L}{\partial V} = - 2 s ( WX - \tilde{W} X ) {X}^{T} \qquad ( 7 )$$

Accordingly, the optimization may be simplified as,

$${V}_{t + 1} = {V}_{t} - lr * sign ( \frac{\partial L}{\partial W} ) \qquad ( 8 )$$

$$s . t . \vert {\sum }_{t} lr * sign ( \frac{\partial L}{\partial W} ) \vert \leq B$$

Moreover, as Eq. (3) averages the loss of each element, which presumes that each element contributes equally to the network, that basically is not true. To alleviate this issue, the rounding task is optimized on a per block basis (e.g., block-wise). In one example, the term “layer” refers to a linear/convolution layer, while the term “block” denotes a transformer block that typically includes several linear layers.

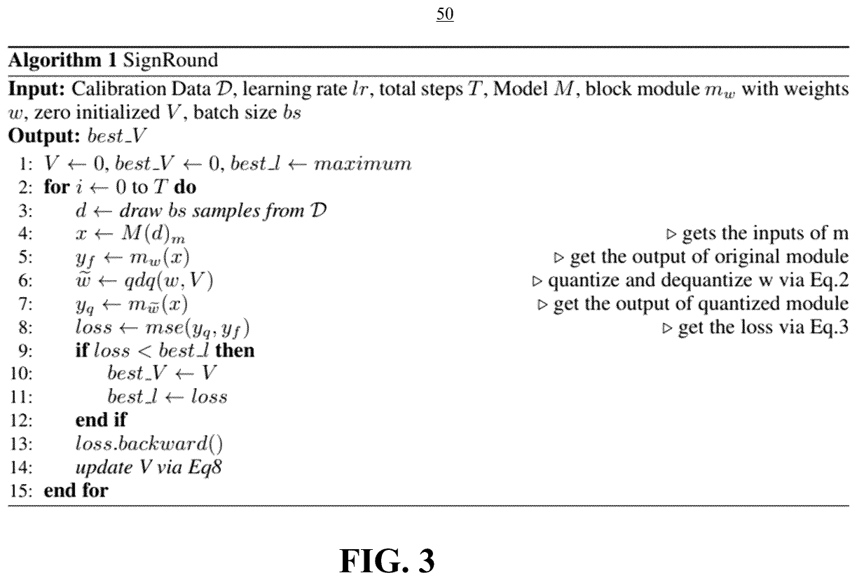

FIG. 3 shows a pseudocode listing 50 to train a tensor V to modify a rounding operation. In one example, the hyperparameters to create a tuning dataset include 512 random samples, with each sample being truncated to a sequence length of 256. The tuning process may involve adjusting each block for 400 steps using a learning rate of 2.5e-3, a batch size of eight, and employing a linear learning rate decay. These hyperparameters can be fine-tuned depending on the deployment. For example, although 4-bit integer (INT4) can reduce computational demands, 4-bit in this context mainly reduces the memory bandwidth instead of computation (e.g., few architectures support INT4 computation). The result is substantially greater accuracy.

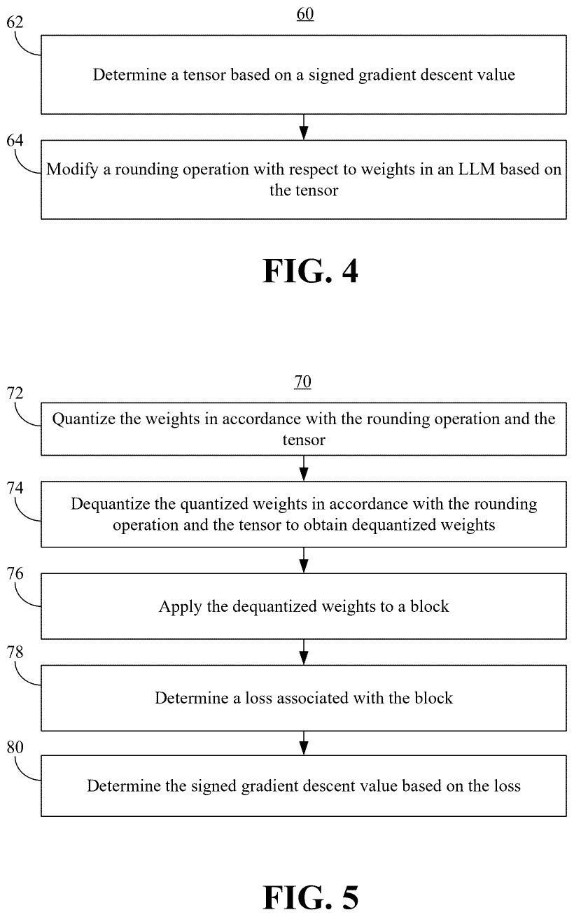

FIG. 4 shows a method 60 of rounding weights in a large language model (LLM). The method 60 may be implemented in one or more modules as a set of logic instructions (e.g., executable program instructions) stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal in oxide semiconductor (CMOS) logic circuits, transistor-transistor logic (TTL) logic circuits, or other circuits.

Computer program code to carry out operations shown in the method 60 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, micro-code, state-setting data, configuration data for integrated circuitry, state information that personalizes electronic circuitry and/or other structural components that are native to hardware (e.g., host processor, central processing unit/CPU, microcontroller, etc.).

Illustrated processing block 62 provides for determining a tensor based on a signed gradient descent value. In an embodiment, the tensor learns relationships between weights in an LLM. Processing block 64 modifies a rounding operation with respect to the weights in the LLM based on the tensor. In one example, the rounding operation is modified on a per block (e.g., multiple layer) basis. The method 60 enhances performance at least to the extent that the signed gradient value and/or the block-wise rounding modification improves the accuracy of the LLM. The LLM can also be trained faster and is useful in a wider range of applications than traditional LLMs.

FIG. 5 shows a method 70 of obtaining a signed gradient descent value. The method 70 may generally be incorporated into processing block 62 (FIG. 4), already discussed. More particularly, the method 70 may be implemented in one or more modules as a set of logic instructions stored in a machine- or computer-readable storage medium such as RAM, ROM, PROM, firmware, flash memory, etc., in hardware, or any combination thereof.

Illustrated processing block 72 quantizes the weights in accordance with the rounding operation and the tensor, wherein processing block 74 dequantizes the weights in accordance with the rounding operation and the tensor to obtain dequantized weights. Processing block 76 applies the dequantized weights to a block and processing block 78 determines a loss associated with the block (e.g., during a forward propagation).

Additionally, processing block 80 determines the signed gradient descent value based on the loss. In an embodiment, processing block 80 constrains the signed gradient descent value to a boundary such as, for example, −0.5 to +0.5.

More particularly, this approach is inspired by the well-defined boundaries of the solution space, which are confined to the range of [−0.5, 0.5], where only the threshold for altering the rounding value is of significance. Firstly, the optimal value is not a single float but typically a large region, negating the need for the gradient magnitude to converge to an exact point. Secondly, due to the limited boundary, this space can be traversed within a constrained number of steps, while the gradient magnitude may vary significantly, making it challenging to determine an appropriate step size within a limited number of iterations. Thirdly, signed gradient descent (SGD) is inherently intuitive, allowing for easy adjustment of the step size (e.g., learning rate). For instance, the same optimizer hyperparameters may include 400 steps and a learning rate of 0.0025, with linear weight decay. This approach ensures that 400*0.0025/2=0.5 covers the range of [−0.5, 0.5].

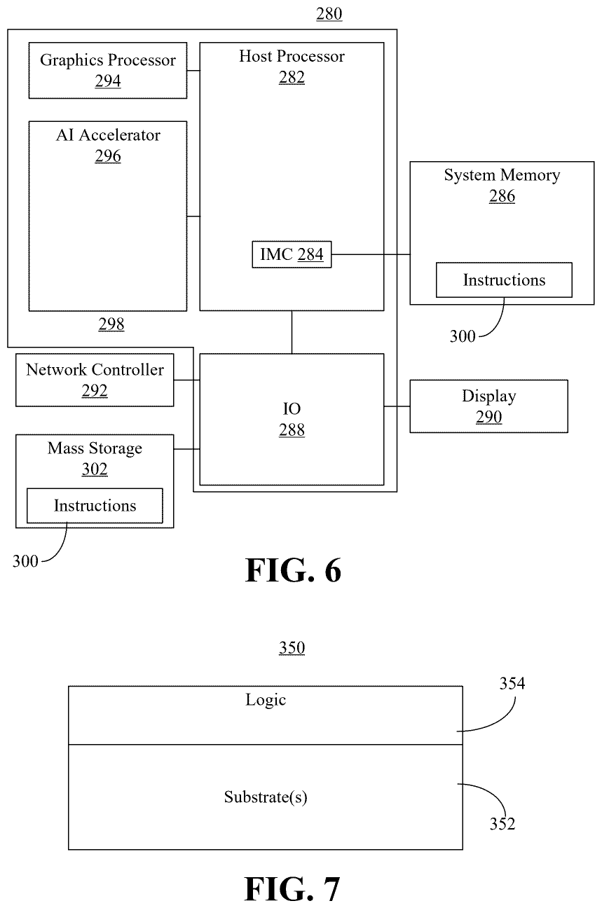

Turning now to FIG. 6, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an artificial intelligence (AI) accelerator 296 (e.g., specialized processor) into a system on chip (SoC) 298.

The host processor 282 and/or the AI accelerator 296 retrieves executable program instructions 300 from the system memory 286 and/or the mass storage 302 and executes the instructions 300 to perform one or more aspects of the method 60 (FIG. 4) and/or the method 70 (FIG. 5), already discussed. Thus, execution of the instructions 300 by the host processor 282 and/or the AI accelerator 296 causes the host processor 282, the AI accelerator 296 and/or the computing system 280 to determine a tensor based on a signed gradient descent value and modify a rounding operation with respect to weights in an LLM based on the tensor. In one example, the rounding operation is modified on a per block basis and the tensor learns relationships between the weights. The computing system 280 is therefore considered performance-enhanced at least to the extent that the signed gradient value and/or the block-wise rounding modification improves the accuracy of the LLM. The LLM can also be trained faster and is useful in a wider range of applications than traditional LLMs.

FIG. 7 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 60 (FIG. 4) and/or the method 70 (FIG. 5), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

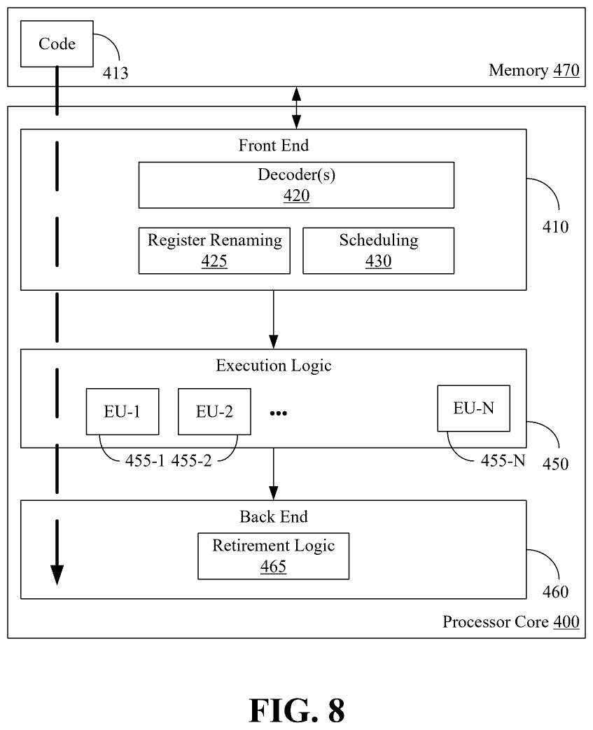

FIG. 8 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 8, a processing element may alternatively include more than one of the processor core 400 illustrated in FIG. 8. The processor core 400 may be a single-threaded core or, for at least one embodiment, the processor core 400 may be multithreaded in that it may include more than one hardware thread context (or “logical processor”) per core.

FIG. 8 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 60 (FIG. 4) and/or the method 70 (FIG. 5), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 8, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

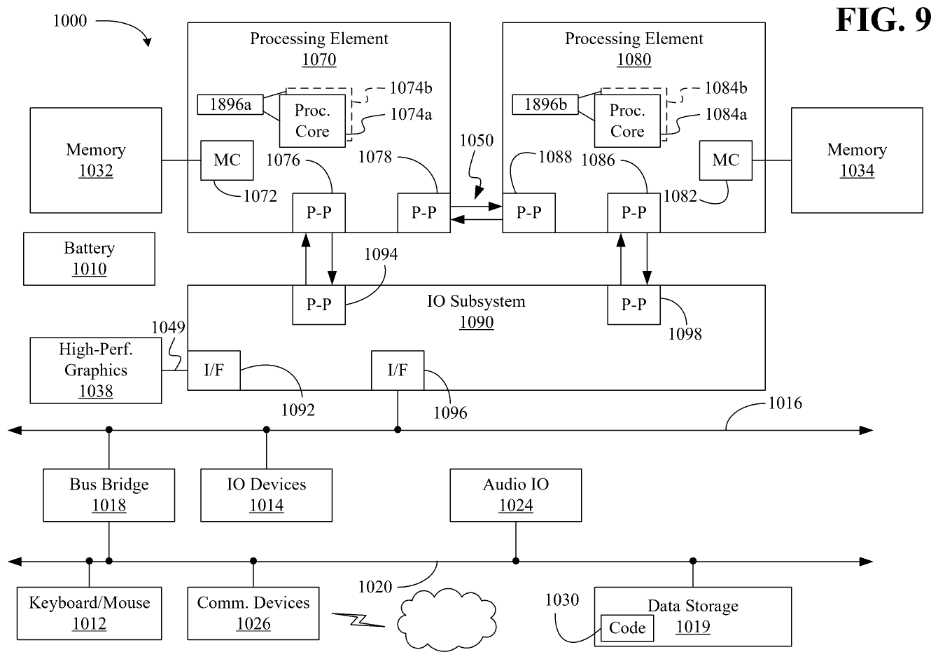

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor.

Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 60 (FIG. 4) and/or the method 70 (FIG. 5), already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

### ADDITIONAL NOTES AND EXAMPLES

Example 1 includes a performance-enhanced computing system comprising a network controller, a processor coupled to the network controller, and a memory coupled to the processor, the memory including one or more executable program instructions, which when executed by the processor, cause the processor to determine a tensor based on a signed gradient descent value and modify a rounding operation with respect to weights in a large language model (LLM) based on the tensor.

Example 2 includes the computing system of Example 1, wherein the rounding operation is modified on a per block basis, and wherein the tensor is to learn relationships between the weights.

Example 3 includes the computing system of Example 1, wherein the one or more executable program instructions, when executed, further cause the processor to constrain the signed gradient descent value to a boundary.

Example 4 includes the computing system of Example 3, wherein the boundary is to be −0.5 to +0.5.

Example 5 includes the computing system of any one of Examples 1 to 4, wherein the one or more executable program instructions, when executed, further cause the computing system to quantize the weights in accordance with the rounding operation and the tensor, dequantize the quantized weights in accordance with the rounding operation and the tensor to obtain dequantized weights, apply the dequantized weights to a block, determine a loss associated with the block, and determine the signed gradient descent value based on the loss.

Example 6 includes at least one computer readable storage medium comprising one or more executable program instructions, which when executed by a computing system, cause the computing system to determine a tensor based on a signed gradient descent value, and modify a rounding operation with respect to weights in a large language model (LLM) based on the tensor.

Example 7 includes the at least one computer readable storage medium of Example 6, wherein the rounding operation is modified on a per block basis.

Example 8 includes the at least one computer readable storage medium of Example 6, wherein the one or more executable program instructions, when executed, further cause the computing system to constrain the signed gradient descent value to a boundary.

Example 9 includes the at least one computer readable storage medium of Example 8, wherein the boundary is to be −0.5 to +0.5.

Example 10 includes the at least one computer readable storage medium of Example 6, wherein the one or more executable program instructions, when executed, further cause the computing system to apply dequantized weights to a block, determine a loss associated with the block, and determine the signed gradient descent value based on the loss.

Example 11 includes the at least one computer readable storage medium of Example 10, wherein the one or more executable program instructions, when executed, further cause the computing system to quantize the weights in accordance with the rounding operation and the tensor, and dequantize the quantized weights in accordance with the rounding operation and the tensor to obtain the dequantized weights.

Example 12 includes the at least one computer readable storage medium of any one of Examples 6 to 11, wherein the tensor is to learn relationships between the weights.

Example 13 includes a semiconductor apparatus comprising one or more substrates, and logic coupled to the one or more substrates, wherein the logic is implemented at least partly in one or more of configurable or fixed-functionality hardware, the logic to determine a tensor based on a signed gradient descent value, and modify a rounding operation with respect to weights in a large language model (LLM) based on the tensor.

Example 14 includes the semiconductor apparatus of Example 13, wherein the rounding operation is modified on a per block basis.

Example 15 includes the semiconductor apparatus of Example 13, wherein the logic is further to constrain the signed gradient descent value to a boundary.

Example 16 includes the semiconductor apparatus of Example 15, wherein the boundary is to be −0.5 to +0.5.

Example 17 includes the semiconductor apparatus of Example 13, wherein the logic is further to apply dequantized weights to a block, determine a loss associated with the block, and determine the signed gradient descent value based on the loss.

Example 18 includes the semiconductor apparatus of Example 17, wherein the logic is further to quantize the weights in accordance with the rounding operation and the tensor, and dequantize the quantized weights in accordance with the rounding operation and the tensor to obtain the dequantized weights.

Example 19 includes the semiconductor apparatus of any one of Examples 13 to 18, wherein the tensor is to learn relationships between the weights.

Example 20 includes the semiconductor apparatus of any one of Examples 13 to 19, wherein the logic coupled to the one or more substrates includes transistor channel regions that are positioned within the one or more substrates.

Example 21 includes a method of operating a performance-enhanced computing system, the method comprising determining a tensor based on a signed gradient descent value, and modifying a rounding operation with respect to weights in a large language model (LLM) based on the tensor.

Example 22 includes an apparatus comprising means for performing the method of Example 21.

The technology described herein provides for weight-only quantization, which offers a favorable tradeoff for the quantization of LLMs. Quantizing activations for LLMs can be challenging, making weight-only quantization a more practical choice. Additionally, the primary bottleneck in generating new tokens for LLMs often lies in memory bandwidth (e.g., if the first token latency is not important and weight only quantization leads to better accuracy). Accordingly, the technology described herein eases the deployment of LLMs. Moreover, since the technology described herein is orthogonal to most traditional weight-only quantization solutions, the technology may be combined with those solutions to achieve even greater accuracy.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A performance-enhanced computing system comprising:
a network controller;
a processor coupled to the network controller; and
a memory coupled to the processor, the memory including one or more executable program instructions, which when executed by the processor, cause the processor to:
determine a tensor based on a signed gradient descent value, and
modify a rounding operation with respect to weights in a large language model (LLM) based on the tensor.

2. The computing system of claim 1, wherein the rounding operation is modified on a per block basis, and wherein the tensor is to learn relationships between the weights.

3. The computing system of claim 1, wherein the one or more executable program instructions, when executed, further cause the processor to constrain the signed gradient descent value to a boundary.

4. The computing system of claim 3, wherein the boundary is to be −0.5 to +0.5.

5. The computing system of claim 1, wherein the one or more executable program instructions, when executed, further cause the computing system to:
quantize the weights in accordance with the rounding operation and the tensor;
dequantize the quantized weights in accordance with the rounding operation and the tensor to obtain dequantized weights;
apply the dequantized weights to a block;
determine a loss associated with the block; and
determine the signed gradient descent value based on the loss.

6. At least one computer readable storage medium comprising one or more executable program instructions, which when executed by a computing system, cause the computing system to:
determine a tensor based on a signed gradient descent value; and
modify a rounding operation with respect to weights in a large language model (LLM) based on the tensor.

7. The at least one computer readable storage medium of claim 6, wherein the rounding operation is modified on a per block basis.

8. The at least one computer readable storage medium of claim 6, wherein the one or more executable program instructions, when executed, further cause the computing system to constrain the signed gradient descent value to a boundary.

9. The at least one computer readable storage medium of claim 8, wherein the boundary is to be −0.5 to +0.5.

10. The at least one computer readable storage medium of claim 6, wherein the one or more executable program instructions, when executed, further cause the computing system to:
apply dequantized weights to a block;
determine a loss associated with the block; and
determine the signed gradient descent value based on the loss.

11. The at least one computer readable storage medium of claim 10, wherein the one or more executable program instructions, when executed, further cause the computing system to:
quantize the weights in accordance with the rounding operation and the tensor; and
dequantize the quantized weights in accordance with the rounding operation and the tensor to obtain the dequantized weights.

12. The at least one computer readable storage medium of claim 6, wherein the tensor is to learn relationships between the weights.

13. A semiconductor apparatus comprising:
one or more substrates; and
logic coupled to the one or more substrates, wherein the logic is implemented at least partly in one or more of configurable or fixed-functionality hardware, the logic to:
determine a tensor based on a signed gradient descent value; and
modify a rounding operation with respect to weights in a large language model (LLM) based on the tensor.

14. The semiconductor apparatus of claim 13, wherein the rounding operation is modified on a per block basis.

15. The semiconductor apparatus of claim 13, wherein the logic is further to constrain the signed gradient descent value to a boundary.

16. The semiconductor apparatus of claim 15, wherein the boundary is to be −0.5 to +0.5.

17. The semiconductor apparatus of claim 13, wherein the logic is further to:
apply dequantized weights to a block;
determine a loss associated with the block; and
determine the signed gradient descent value based on the loss.

18. The semiconductor apparatus of claim 17, wherein the logic is further to:
quantize the weights in accordance with the rounding operation and the tensor; and
dequantize the quantized weights in accordance with the rounding operation and the tensor to obtain the dequantized weights.

19. The semiconductor apparatus of claim 13, wherein the tensor is to learn relationships between the weights.

20. The semiconductor apparatus of claim 13, wherein the logic coupled to the one or more substrates includes transistor channel regions that are positioned within the one or more substrates.
